(19) United States
(12) Patent Application Publication
(10) Pub. No.: US 2023/0404833 A1
(43) Pub. Date: Dec. 21, 2023

(54) Massage Roller Apparatus

(71) Applicant: Yoan Bantchev, Las Vegas, NV (US)

(72) Inventor: Yoan Bantchev, Las Vegas, NV (US)

(21) Appl. No.: 17/749,183

(22) Filed: May 20, 2022

(51) Int. Cl. A61H 1/00

(52) U.S. Cl. CPC A61H 1/005; A61H 2015/0035

(57) ABSTRACT

The present disclosure provides a massage roller apparatus comprising a frame supporting a rod with a freely rolling wheel disposed thereon and a sliding platform either side that provide support for the user's head and buttocks areas respectively. The platforms can each slide closer to or further from the massage roller in the centre to position the user, and can take as much of the user's weight as is desired. A user can thus place their body in an ergonomically comfortable position, with their muscles relaxed and their spine in a neutral position, whilst still allowing for specific muscle groups to be targeted with the roller. The rod holding the massage roller is also detachable, and can be replaced with different roller types and configurations to suit the desired massage type.

### FIELD OF INVENTION

The present invention relates generally to massage roller apparatus. More specifically, the present invention relates to a massage roller with freely sliding platforms for supporting a user as they roll.

### BACKGROUND

Foam rolling is a self-myofascial release (SMR) technique where a user moves their body over a massage roller device to apply pressure to specific muscle groups. It is becoming increasingly popular as a method of targeted muscle massage, with more and more evidence showing the benefit of this practice with possible effects of helping relieve muscle tightness, soreness, inflammation, and providing an increase in an individual's joint range of motion.

The problem with foam rolling is that it can be uncomfortable because the amount of pressure applied to the muscle groups is determined by a combination of a user's weight and how much they engage the muscles across their body to take that weight and thus reduce the pressure. This means that a user wishing to feel less pressure has to engage the very muscles they are trying to massage, which reduces effectiveness. In severe cases, this tension of muscle engagement versus bodily weight supported by the foam roller can lead to injury.

Furthermore, users practicing foam rollers must do so on the floor, which can also be uncomfortable, and which can cause clothes to be dirtied if a suitable space is not available.

There are some solutions available which utilize raised frames with freely rolling wheels to counteract some of these issues, but it is often the case that the flexibility of foam rolling, a key benefit of the simple foam massage roller, is lost when the roller is mounted on a frame.

It is within this context that the present invention is provided.

### SUMMARY

The present disclosure provides a massage roller apparatus comprising a frame supporting a rod with a freely rolling wheel disposed thereon and a sliding platform either side that provide support for the user's head and buttocks areas respectively. The platforms can each slide closer to or further from the massage roller in the centre to position the user, and can take as much of the user's weight as is desired. A user can thus place their body in an ergonomically comfortable position, with their muscles relaxed and their spine in a neutral position, whilst still allowing for specific muscle groups to be targeted with the roller. The rod holding the massage roller is also detachable, and can be replaced with different roller types and configurations to suit the desired massage type.

Thus, according to one aspect of the present disclosure there is provided a massage roller apparatus, comprising: a frame, the frame being formed of a first section comprising a first supporting rail track and a second section comprising a second supporting rail track, the first supporting rail track and the second supporting rail track being parallel to one another and positioned either side of a mounting point; a first platform slidably connected to the first supporting rail track; a second platform slidably connected to the second supporting rail track; a detachable rods having one or more massaging roller wheels fitted thereon and configured to detachably connect to the mounting point of the frame while allowing rotation about a central axis of the rod, which is orthogonal to the direction of the supporting rail tracks.

The frame is configured such that first platform and second platform rest on a shared plane to support the buttocks and head of a user, respectively, and further configured such that a portion of the massaging roller wheels pass through that plane to facilitate targeted massage of muscle groups between the head and buttocks by movement of the first and second platforms with respect to the roller wheels.

In some embodiments, the frame has a first pair of handles disposed either side of the first supporting rail track for assisting a user in lowering themselves down to rest on the first platform. The first pair of handles may be detachable.

In some embodiments, the frame has a second pair of handles disposed either side of the second supporting rail track for assisting a user in moving the slidable platforms to a desired position with respect to the roller wheels. The second pair of handles may be detachable.

In some embodiments, the frame comprises a plurality of supporting legs for raising the plane of the platforms to a suitable ergonomic position above the floor.

In some embodiments, the apparatus is provided with two or more detachable rods, each having different configurations of roller wheels. For example, the number of wheels between different rods may vary, the material of construction of the wheels on the different rods may vary, and the size of the wheels on the different may vary.

In some embodiments, the top of the platforms are provided with a textured surface to increase friction and prevent a user form sliding off accidentally.

In some embodiments, the frame is foldable.

### BRIEF DESCRIPTION OF THE DRAWINGS

Various embodiments of the invention are disclosed in the following detailed description and accompanying drawings.

FIG. 1 illustrates an isometric view of an example massage roller apparatus according to the present disclosure with first and second platforms positioned distally from the central massage roller.

FIG. 2 illustrates an isometric view of the example configuration of the massage roller apparatus with the first platform positioned distal to the central massage roller and the second platform positioned proximal to it.

FIG. 3 illustrates an isometric view of the example configuration of the massage roller apparatus with the first platform positioned proximal to the central massage roller and the second platform positioned distally.

FIG. 4 illustrates an isometric view of the example configuration of the massage roller apparatus with both the first and second platforms positioned proximal to the central massage roller.

FIG. 5 illustrates an isometric view of the example configuration of the massage roller apparatus with an alternate massage roller rod fitted, and both of the platforms positioned distally from it.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As mentioned above, the massage roller apparatus of the present disclosure utilizes a frame and sliding platform configuration to support a user's body weight and allow for versatile positioning of their body while they target muscle areas with the roller wheels. When the user places the weight of his head and buttocks on the respective sliding platforms, the muscles of their back relax, increasing the efficacy of the massage. Taking this strain away from the rest of the body even allows for more pressure to be applied to the targeted areas. It also supports the spine, allowing it to remain in a neutral position and reducing injury risk.

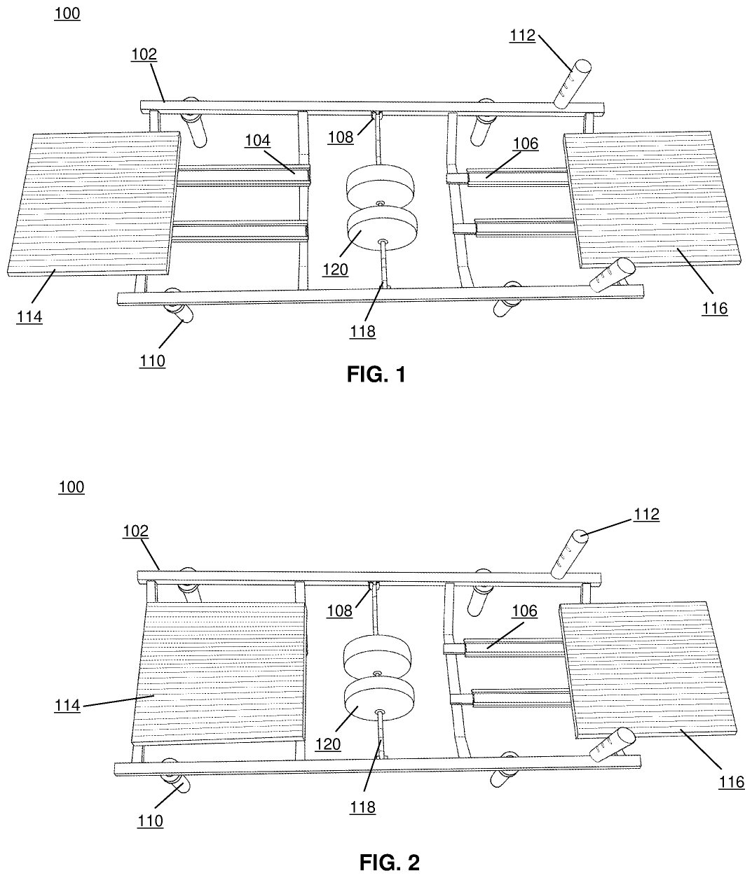

Referring to FIG. 1, an example configuration of the massage roller apparatus 100 according to the present disclosure is shown in a perspective view.

As can be seen, the apparatus 100 is comprised of a frame 102 that in this case has a pair of parallel railings running its full length. Two pairs of sliding rail tracks 104 and 106 are supported between these railings by lateral connecting bars, and first and second supporting platforms 114 and 116 are slidably mounted atop each of the rail tracks 104 and 106. The rail tracks 104 and 106 are disposed at either end of the apparatus and define the range of movement of the sliding platforms along its length.

A mounting point 108 is positioned between the rail tracks, upon which a rod 118 with a massage roller wheel 120 can be detachably mounted. The rod has a central axis angled orthogonally to the direction of the parallel rail tracks 104 and 106 and thus to the direction in which the platforms 114 and 116 are configured to slide. Since the rod 118 is rotatably connected to mounting point 108, and is positioned at a height level where the roller wheel 120 will pass through the plane along which the platforms 114 and 116 slide, a person resting atop the platforms and sliding back and forth will cause the wheel 120 to rotate about the axis of the rod, allowing for targeted massage.

The example configuration of the apparatus 100 is mounted atop four supporting legs 110 which elevate the entire assembly above the floor for more ergonomic positioning and so that the wheel 120 can rotate freely.

A pair of handles 112 is affixed to one side of the apparatus 100. These handles may be detachable, and help a user lower themselves down onto the platform 116. In some examples, a separate second pair of handles may be mounted to the opposing side of the apparatus so that a user can more easily adjust the position of the sliding platforms on which they are resting with respect to the position of the massage roller wheel 120.

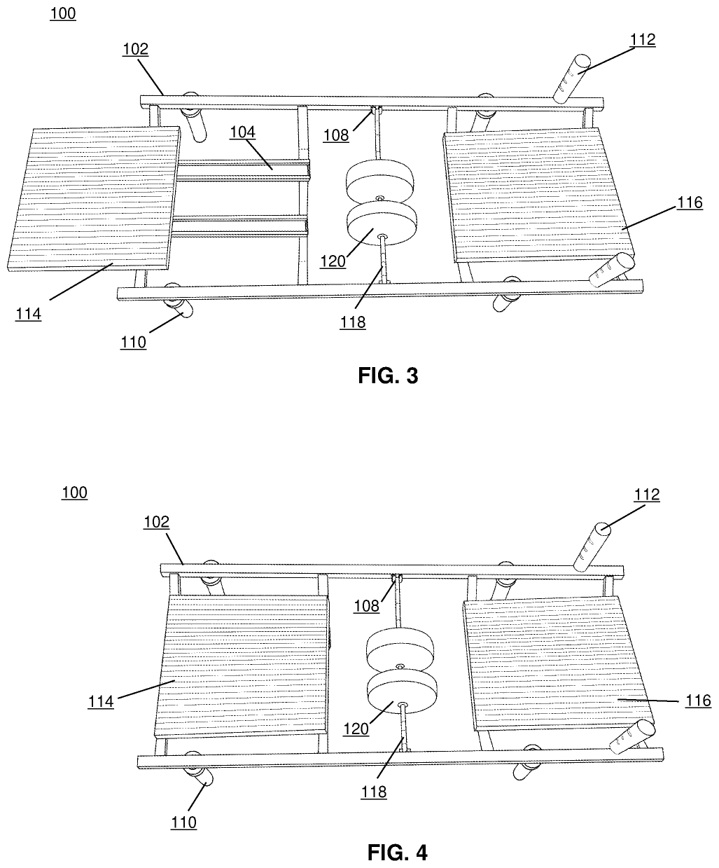

FIG. 2-FIG. 4 all show different possible positions of the platforms 114 and 116, the movement of which is independent of one another, along the rail tracks 104 and 106.

As the rod 118 is detachable from mounting point 108, various different types of rod may be provided with the apparatus to suit different users and massage types.

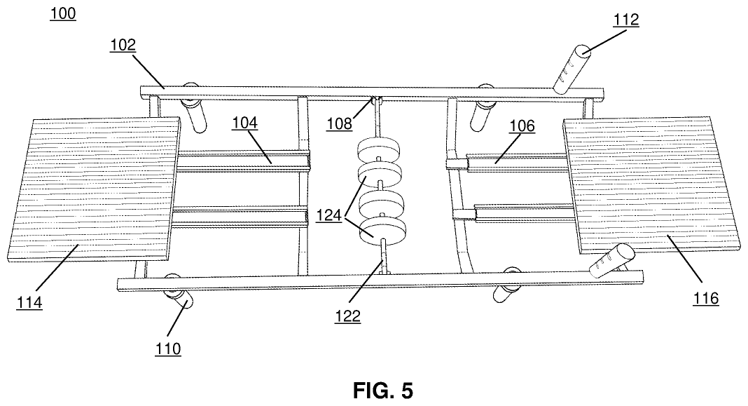

FIG. 5 shows the same example apparatus but with a different massage rod 122 having four smaller massage roller wheels 124 disposed along its length. This shows that the numbers and size of the wheels can both be changed. The positions of the wheels along the rod, the shape profile of the wheels, and the material of which they are made can also be changed. For example, wheels formed of harder materials may be provided for when a user wants to target muscles more intensely.

Although not illustrated, the frame 102 may also be constructed so that it is foldable, making it easier to store and transport between uses.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the massage roller apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A massage roller apparatus, comprising:
a frame, the frame being formed of a first section comprising a first supporting rail track and a second section comprising a second supporting rail track, the first supporting rail track and the second supporting rail track being parallel to one another and positioned either side of a mounting point;
a first platform slidably connected to the first supporting rail track;
a second platform slidably connected to the second supporting rail track;
a detachable rods having one or more massaging roller wheels fitted thereon and configured to detachably connect to the mounting point of the frame while allowing rotation about a central axis of the rod, which is orthogonal to the direction of the supporting rail tracks;
wherein the frame is configured such that first platform and second platform rest on a shared plane to support the buttocks and head of a user, respectively, and further configured such that a portion of the massaging roller wheels pass through that plane to facilitate targeted massage of muscle groups between the head and buttocks by movement of the first and second platforms with respect to the roller wheels.

2. A massage roller apparatus according to claim 1, wherein the frame has a first pair of handles disposed either side of the first supporting rail track for assisting a user in lowering themselves down to rest on the first platform.

3. A massage roller apparatus according to claim 2, wherein the first pair of handles are detachable.

4. A massage roller apparatus according to claim 1, wherein the frame has a second pair of handles disposed either side of the second supporting rail track for assisting a user in moving the slidable platforms to a desired position with respect to the roller wheels.

5. A massage roller apparatus according to claim 4, wherein the second pair of handles are detachable.

6. A massage roller apparatus according to claim 1, wherein the frame comprises a plurality of supporting legs for raising the plane of the platforms to a suitable ergonomic position above the floor.

7. A massage roller apparatus according to claim 1, wherein the apparatus is provided with two or more detachable rods, each having different configurations of roller wheels.

8. A massage roller apparatus according to claim 7, wherein the number of wheels between different rods varies.

9. A massage roller apparatus according to claim 7, wherein the material of construction of the wheels on the different rods varies.

10. A massage roller apparatus according to claim 7, wherein the size of the wheels on the different rods varies.

11. A massage roller apparatus according to claim 1, wherein the top of the platforms are provided with a textured surface to increase friction and prevent a user form sliding off accidentally.

12. A massage roller apparatus according to claim 1, wherein the frame is foldable.
